(19) United States
(12) Patent Application Publication
(10) Pub. No.: US 2023/0068652 A1
(43) Pub. Date: Mar. 2, 2023

(54) LED DOWN LIGHTS

(71) Applicant: M and N Technology LLC, Red Bank, NJ (US)

(72) Inventor: John N. MAGNO, St. James, NY (US)

(21) Appl. No.: 17/760,355

(22) PCT Filed: Feb. 10, 2021
(86) PCT No.: PCT/US2021/017309

§ 371 Date: Aug. 8, 2022

Related U.S. Application Data
(60) Provisional application No. 62/972,220, filed on Feb. 10, 2020.

(51) Int. Cl. F21S 8/02; F21V 7/05; F21V 5/00

(52) U.S. Cl. CPC F21S 8/02; F21V 7/05; F21V 5/00; F21Y 2115/10

(57) ABSTRACT

Light fixtures and methods of making the same which include an outer container includes a back wall and one or more outer walls extending upward from the periphery of the back wall, wherein the walls of the outer container form a cavity, wherein the one or more surfaces of the one or more outer walls of the outer container that face inward are coated with, painted with or intrinsically have diffuse, white reflecting surfaces, wherein one or more of the inward facing surfaces of the one or more outer walls of the outer container have circuit boards, flexible circuit boards or tapes mounted on or adhered to them, wherein the circuit boards, flexible circuit boards, or tapes have light emitting devices mounted on them, and wherein the cavity formed by the outer walls of the container is filled with a clear, transparent material.

### CROSS-REFERENCE TO RELATED APPLICATION

This application claims the benefit under 35 U.S.C. § 119(e) of the earlier filing date of U.S. Provisional Application No. 62/972,220 filed on Feb. 10, 2020, the disclosure of which is incorporated by reference herein.

### BACKGROUND

Light emitting diodes (LEDs) are replacing incandescent and fluorescent lamps in most architectural applications because of their energy efficiency and superior performance. An important architectural application is that of down lights. Down lights are generally installed on ceilings or other surfaces that overhang work, commercial or residential areas. They differ from linear lighting in that they are designed to illuminate a relatively restricted and symmetric area under the down light fixture. For instance, recessed or can lights are examples of down lights.

There a number of requirements or desirable parameters for LED down light performance. The down light fixtures should be energy efficient. The energy efficiency of an LED-based down light fixture not only depends on the intrinsic efficiency of the LEDs, but also on the energy efficiency of the redirection of light emitted by the LEDs so as to channel the light into the desired footprint area under the light. This is illustrated by FIG. 1. Down light 110 is intended to light an area on surface 120 with a width W. This area is defined by the light emission cone angle α. The energy efficiency of down light 110 is greatly impacted by the energy efficiency of the process that channels light emitted by the LEDs in fixture 110 into the cone defined by angle α. It is in this channeling process that many LED down lights suffer considerable loss in energy efficiency. An LED down light design concept should allow fixtures that yield different cone angles α to be designed that all maintain high energy efficiency.

Another important requirement of down lights is the distribution of light achieved over the area of width W. For instance, in FIG. 2 light distribution 210 yields a flat field of illumination over the area of width W (as defined by distances W/2 and −W/2 from the central axis of the cone of illumination). In some applications a different light distribution may be required. Distribution 220 is typical of such a requirement that yields a nearly Gaussian distribution of light. In addition, an important aspect of the light distribution pattern of an LED down light is the amount of local variation from the desired light distribution. As an example, in light distribution 210 local variations from the desired illumination level (local non-uniformity of illumination) can affect one's ability to perform tasks within the lighted area. A down light design concept should be able to be easily modified to produce a desired light distribution over the area defined by a cone angle α with an acceptable uniformity in the lighted area.

There is a wide variation in light output intensity required in LED down lights depending on the application. Therefore, it is desirable that a LED down light design concept allow the total light output of a fixture to be varied over a wide range of values. Since the light output of reasonably priced individual LEDs has an upper limit, producing fixtures that produce more light involves designing more LEDs into the fixture. It is therefore desirable that an LED down light design concept allows a wide variation in the number of LEDs used.

A further complication in utilizing increased numbers of LEDs in a light fixture is that LEDs produce heat as a by-product of light emission. If a significant number of LEDs are designed into a small area in a light fixture, the heat production in that area will necessitate the use of some sort of heat sink to dissipate the heat produced. The incorporation of a heat sink into a light fixture design will result in an addition of unwanted weight and volume to the light fixture and increase its cost.

Other considerations in the design of downlight fixtures are that they are aesthetically pleasing when illuminated and produce minimal unwanted glare. In practice this means that the light output be uniform across the fixture, i.e. there are no hotspots.

While there are several LED down light designs that address some the performance issues above, no current design yields performance that is completely satisfactory.

### BRIEF DESCRIPTION OF THE DRAWINGS

FIG. 1 illustrates the emission cone of a conventional lamp.

FIG. 2 illustrates alternative distributions of light emitted from lamps.

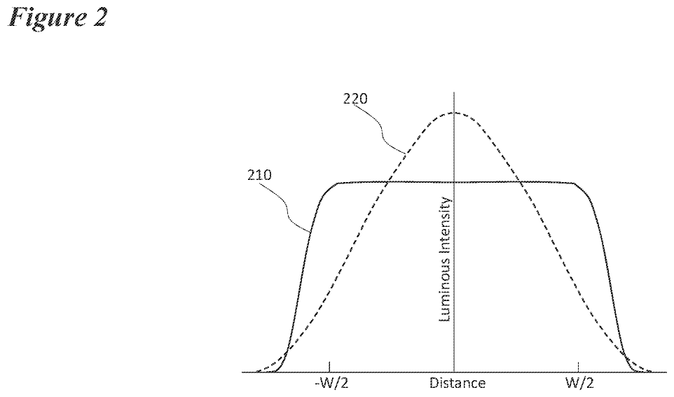

FIG. 3 illustrates a plan view of a circular lamp of the invention.

FIG. 4 illustrates a cross-sectional view of the circular lamp illustrated in FIG. 3.

FIG. 5 illustrates a magnified end portion of another lamp of the invention.

FIG. 6 illustrates an edge-on view of the circular lamp illustrated in FIG. 3.

FIG. 7 illustrates an edge-on view of a transparent disk comprised by another lamp of the invention.

FIG. 8 illustrates a cross-sectional view of the lamp that comprises the transparent disk illustrated in FIG. 7.

FIG. 9 illustrates a plan view of a square lamp of the invention.

FIG. 10 illustrates a cross-sectional view of the square lamp illustrated in FIG. 9.

FIG. 11 illustrates a plan view of a rectangular lamp of the invention.

FIG. 12 illustrates a cross-sectional view of the rectangular lamp illustrated in FIG. 11.

FIG. 13 illustrates a cross-sectional view of another circular lamp of the invention.

FIG. 14 illustrates a plan view of the lamp illustrated in FIG. 13.

FIG. 15 illustrates a plan view of another square lamp of the invention.

FIG. 16 illustrates a plan view of another lamp of the invention.

FIG. 17 illustrates a cross-sectional view of the lamp illustrated in FIG. 16.

### DESCRIPTION OF THE INVENTION

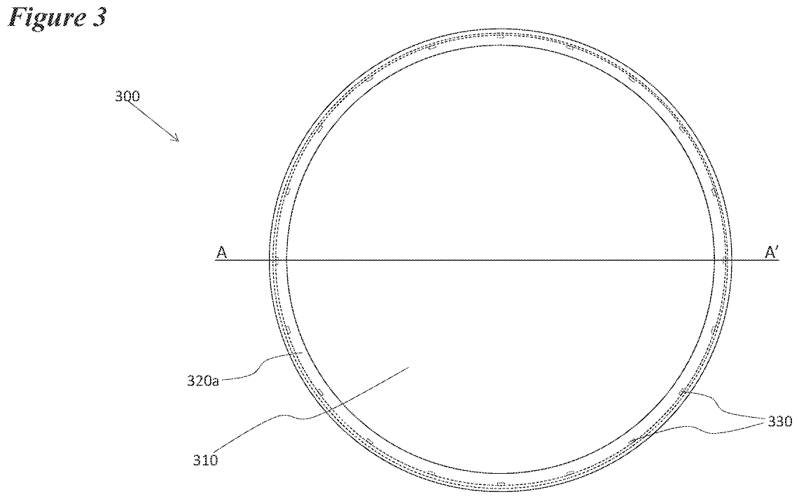

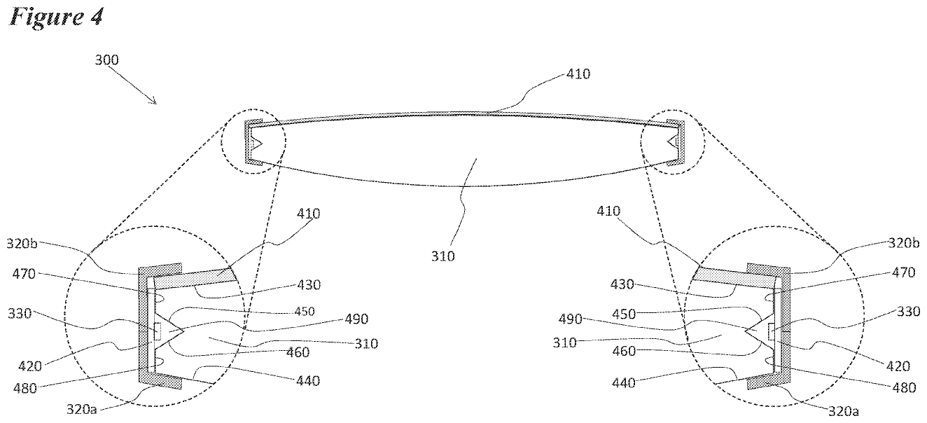

An embodiment 300 of the invention is portrayed in a plan view in FIG. 3. A cross-section of this embodiment along axis AA′ is portrayed in FIG. 4. The down light fixture 300 comprises a disk of transparent material such as polymethylmethacrylate or sol-gel glass 310. The disk is bounded front and back by two surfaces 440 and 430. The periphery of the disk is bounded by four surfaces 480, 460, 450 and 470. Surfaces 450 and 460 form two sides of a cavity 490 that has a triangular cross section and that extends completely around the periphery of the disk. Surfaces 470 and 480 connect the inner surfaces 450 and 460 to the surfaces 430 and 440. In this embodiment surfaces 470 and 480 are of equal width. A flexible circuit board or tape 420 is in contact with surfaces 470 and 480 around the periphery of disk 310. LEDs 330 are mounted on the flexible circuit board 420 with their light emissive surfaces oriented so as to emit light outward from the flexible circuit board into cavity 490. The LEDs are in contact with an electrical circuit and through that circuit to a power supply (not shown) such that they can be energized. The embodiment portrayed in FIGS. 3 and 4 has twenty LEDs arrayed around the periphery of disk 310. The number of LEDs can increased or reduced from this number depending on the light intensity required to be emitted from the fixture. A reflector 410 is in contact with or is proximate to rear surface 430 such that light exiting surface 430 is reflected back into disk 310. Reflector 410 may be a diffuse reflector or a specular reflector or a combination of the two. A diffuse reflector is preferred. A bezel or circular frame surrounds the periphery of the disk/LED circuit board/reflector assembly. In this embodiment the bezel comprises two halves 320a and 320b that are joined together to support the flexible circuit board 420.

The light emitting diodes 330 emit light into the cavity 490. The emitted light traverses the air-filled cavity 490 and is either transmitted or reflected by the material interfaces at the surfaces 450 and 460. Light emitted from the light emitting diodes 330 encounters interfaces between the air in the cavity 490 and the transparent solid material comprising disk 310. Light passing through surfaces 450 and 460 passes through disk 310 and may exit through surface 440 into the surrounding environment or it may be reflected from reflector 410 resulting in redirection out through surface 440 into the surrounding environment. Optionally a reflector (not shown) may be positioned between flexible circuit board 420 and surfaces 470 and 480 and also over the circuit board 420 surface that faces into cavity 490 in locations on the circuit board not occupied by LEDs. It will be appreciated that the great majority of light produced by the light emitting diodes 330 will either immediately be transmitted through the surfaces 450 and 460 immediately or be recycled one or more times from the “faces” of the cavity 490 finally exiting the cavity through the surfaces 470 and 480.

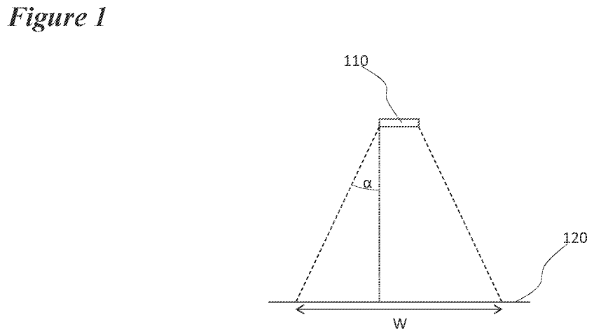

Surfaces 430 and 440 are convex in the embodiment shown in FIGS. 3 and 4. These surfaces play a strong role in determining the value of angle α as defined in FIG. 1. The convex nature of surface 440, for instance, will tend to reduce the value of a. If surface 440 is made to have a concave curvature, it will tend to increase the value of a. By adjusting the curvature of surfaces 430 and 440 from convex to planar to concave the value of a can be adjusted and to an extent the distribution of light within the cone defined by a can also be adjusted.

Reflector 410 may be bonded to disk 310 or there may be an air-gap between reflector 410 and disk 310. Reflector 410 may have the same curvature as surface 430 and thus be in close proximity to it over the full extent of surface 430 or reflector 410 may have a different curvature than surface 430 such that the air-gap between the two varies across surface 430.

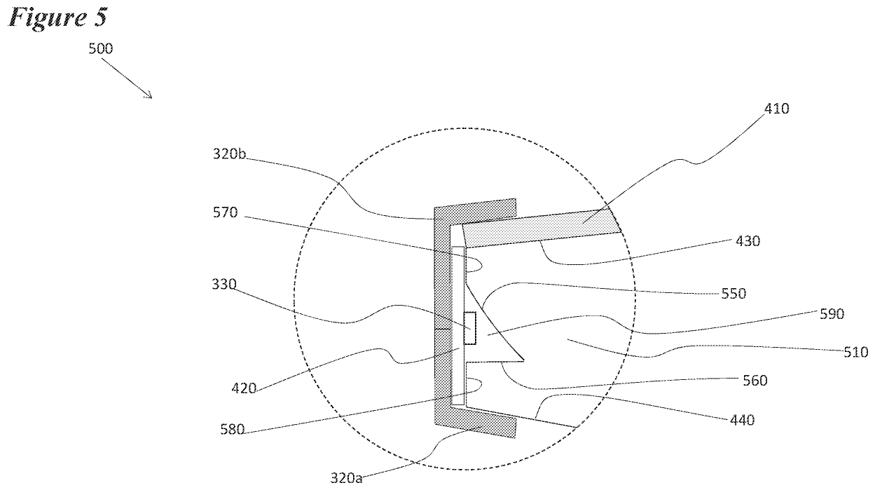

In the embodiment shown in FIG. 4 the surfaces 450 and 460 are planar, they form the same angles where they meet surfaces 470 and 480, and the apex where they meet is centered over LEDs 330. It is an important variable in the design concept of the invention that surfaces 450 and 460 may be curved so as to act like cylindrical lenses and that the angle at the intersection of surface 460 with surface 480 may be different from the angle at the intersection of surface 450 with surface 470. Further, the vertex at the intersection of surfaces 450 and 460 need not be centered over LEDs 330. Surfaces 470 and 480 may have unequal widths and, in fact, may not exist at all. An example of these design variables is portrayed in FIG. 5. The figure portrays a magnified end portion of an embodiment 500 of the invention. In this embodiment two sides of cavity 590 are formed by surfaces 550 and 560. Surface 550 is a curved surface and behaves like a concave cylindrical lens for light emitted from LEDs 330. Surface 560 is a planar surface that forms a much steeper angle at its intersection with surface 560 than surface 460 forms at its intersection with surface 480 in embodiment 300. The apex of cavity 590 is not centered over LEDs 330 and surface 570 is less wide than surface 580. An important point is that light exiting surface 550 is diverged by its interaction with the concave cylindrical lens equivalent thus spreading it out over surface 430 of embodiment 500 and over thus spreading out the area it encounters on reflector 410 of embodiment 500. By this example it can be seen that the distribution of light across reflector 410 and thus the distribution of light over the area of diameter W in FIG. 1 is strongly affected by the curvature and orientation of the surfaces that form cavities corresponding to cavity 490 of embodiment 300 of the invention. By tuning curvature of surfaces corresponding to surfaces 430 and 440 and of reflector 410 of embodiment 300 and the curvature, positioning and orientation of surfaces corresponding to surfaces 450 and 460 of embodiment 300 of the invention it is possible to tune the value of a and to control the distribution of light within the area illuminated by the light fixtures of the invention.

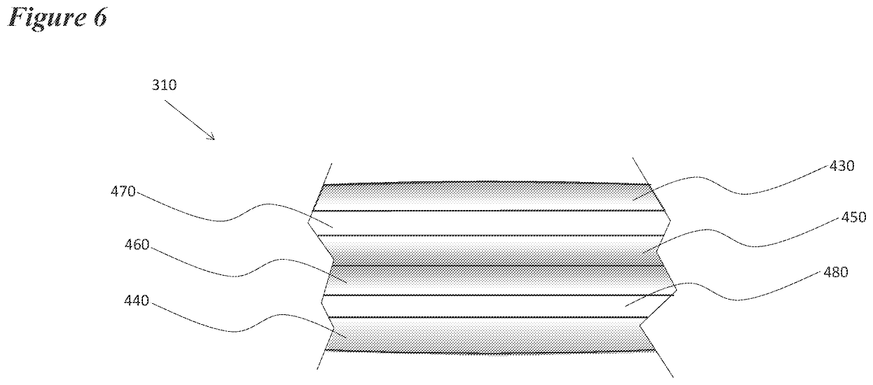

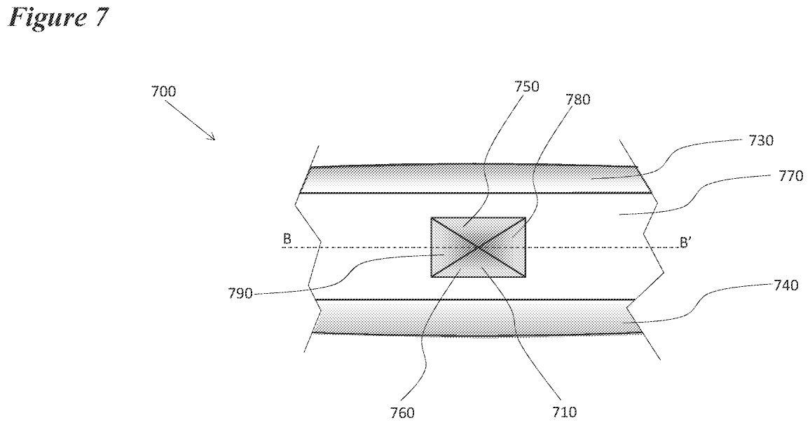

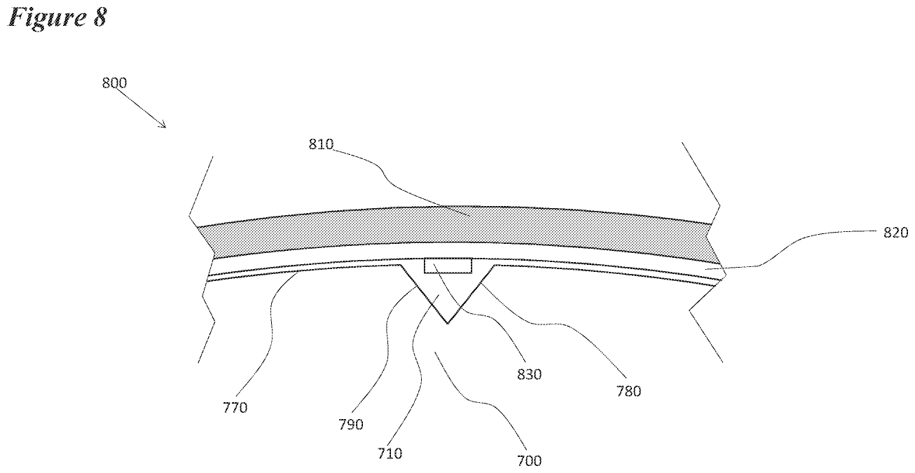

The cavity in the periphery of the disk comprised by embodiments of the invention similar to those discussed above need not extend completely around the periphery of the disk. In order to describe embodiments of this type it is useful to view the transparent disk 310 from embodiment 300 from FIG. 3 from its edge. This view is portrayed in FIG. 6. Surfaces 430, 440, 450, 460, 470, and 480 are portrayed in this figure. FIG. 7 portrays a similar view of the edge of the disk 700 of transparent material from another embodiment of the invention in which the surfaces analogous to surfaces 450 and 460 that define a cavity 710 analogous to cavity 490 in FIG. 4 do not extend around the periphery of the disk. The transparent disk 700 of this embodiment has a series of discrete cavities that extends around the periphery of disk 700. Surfaces 750, 760, 780, and 790 form the cavity 710 shown in FIG. 7. If the light fixture of this embodiment incorporates twenty LEDs, there would be twenty cavities evenly spaced around the periphery of the disk 700. FIG. 8 portrays a segment of a cross-sectional view of a LED down light fixture 800 along axis BB′ shown in FIG. 7. LED 830 is mounted on flexible circuit board 830 that is in turn mounted on bezel 820. LED 830 is centered on cavity 710 formed in the periphery of disk 700. Surfaces 750 and 760 of cavity 710 interact with light in a manner similar to the manner in which surfaces 450 and 460 interact with light generated in embodiment 300. Surfaces 780 and 790 interact with light in an analogous manner dispersing light laterally in disk 700. This may be advantageous in terms of improving the uniformity of illumination across area illuminated by fixture 800. As was the case with surfaces 440 and 450 of embodiment 300, surfaces 750, 760, 780, and 790 need not be planar and utilizing curved surfaces may be advantageous in terms of uniformly dispersing light across the area illuminated by fixture 800. As was the case in embodiments 300 and 500, the number of LEDs 830 and corresponding cavities 710 around the periphery of disk 700 may be decreased or increased depending on the intensity of illumination required.

The embodiments of this invention described above are superior in their performance to existing LED down light fixtures in that the location, orientation, curvature of surfaces such as 430, 440, 450, 460, 550, 560, 730, 740, 750, 760, 780, and 790 can be tuned so as to produce a desired light distribution in an illuminated area with a desired level of illumination uniformity. In addition, the intensity of illumination can be easily adjusted by increasing or decreasing the number of LEDs arrayed around the periphery of the fixtures without a heat sink being required.

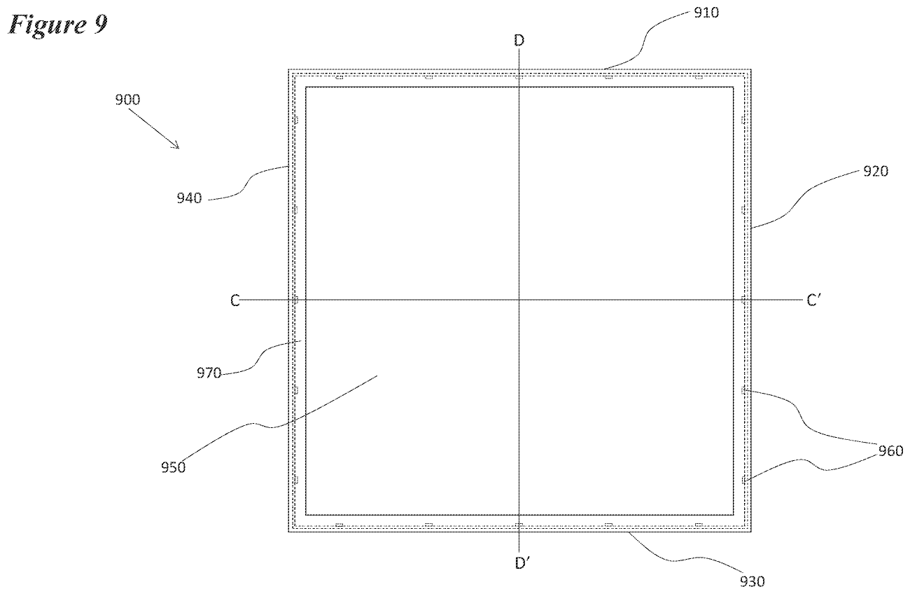

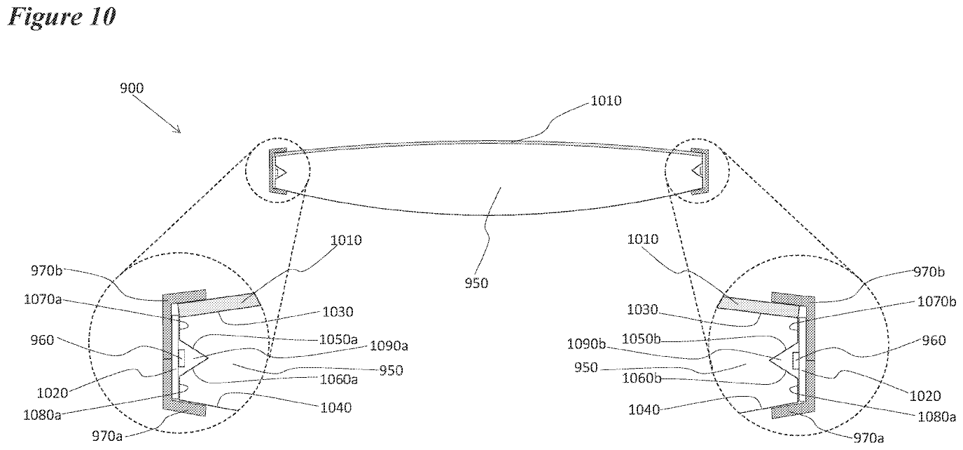

A further embodiment 900 of the invention is portrayed in plan view in FIG. 9 and in cross-sectional view along axis CC′ in FIG. 10. Embodiment 900 comprises a square slab 950 of transparent material such as polymethylmethacrylate or sol-gel glass and LEDs 960. Down light fixture 900 has four sides 910, 920, 930, and 940. Slab 950 is bounded front and back by two surfaces 440 and 430. On side 940 slab 950 is bounded by surfaces 1050a, 1060a, 1070a, and 1080a (as shown in FIG. 10). Surfaces 1050a and 1060a form two sides of a cavity 1090a that has a triangular cross section and extends along the side of slab 950 that faces side 940. Surfaces 1070a and 1080a connect the inner surfaces 1050 and 1060 to the surfaces 1030 and 1040 respectively. Similarly, on side 920 slab 950 is bounded by surfaces 1050b, 1060b, 1070b, and 1080b. Surfaces 1050b and 1060b form two sides of a cavity 1090b that has a triangular cross section and extends along the side of slab 950 that faces side 920. Surfaces 1070b and 1080b connect the inner surfaces 1050b and 1060b to the surfaces 1030 and 1040 respectively. In this embodiment surfaces 1070b and 1080b are of equal width. Because the down light fixture 900 is square and is symmetric on all four sides, the surfaces bounding slab 950 on sides 910 and 930 are the same as those bounding slab 950 on sides 920 and 940. A flexible circuit board or tape 1020 is in contact with surfaces 1070a and 1080a of slab 950 on side 940 and surfaces 1070b and 1080b of slab 950 on side 920 as well as the corresponding surfaces of slab 950 on sides 910 and 930. Four separate flexible circuit boards may be substituted for flexible circuit board 1020, one on each side of down light fixture 900. LEDs 960 are mounted on the flexible circuit board 1020 with their light emissive surfaces oriented so as to emit light outward from the flexible circuit board into cavities 1090a, 1090b and their equivalents on sides 910 and 930 of slab 950. The LEDs are in contact with an electrical circuit and through that circuit to a power supply (not shown) such that they can be energized. The embodiment portrayed in FIGS. 9 and 10 has twenty LEDs arrayed around the periphery of slab 950. The number of LEDs can be increased or reduced from this number depending on the light intensity required to be emitted from the fixture. A reflector 1010 is in contact with or is proximate to rear surface 1030 such that light exiting surface 1030 is reflected back into slab 950. Reflector 1010 may be a diffuse reflector or a specular reflector or a combination of the two. A diffuse reflector is preferred. In this embodiment the bezel 970 comprises two halves 970a and 970b that are joined together to support the flexible circuit board 1020. Reflector 1010 may or may not have the same curvature as surface 1030 of slab 950. If it has a different curvature, an airgap between reflector 1010 and surface 1030 will result.

Surfaces 1030 and 1040 are convex in the embodiment 900 shown in FIGS. 9 and 10. They may be convex with spherical or parabolic or other 2-D curvature profiles or the surfaces may have a cylindrical symmetry. That is to say, surfaces 1030 and 1040 may have curved surface profiles along axes parallel to axis CC′, but have no curvature along axes parallel to axis DD′. Surfaces 1030 and 1040 may also have flat or concave surface profiles along axes parallel to axis CC′ or along both axes parallel to CC′ and along axes parallel to DD′. The ability to have different curvatures of surfaces along axes parallel to CC′ as opposed to curvatures of surfaces along DD′ may be of considerable utility if different light distributions are desired across one direction in the illuminated area versus the other direction in the illuminated area.

Surfaces 1050a, 1060a, 1050b, and 1060b are shown to be planar in FIG. 10. However, one or more of these surfaces may be curved as well as one or more of the equivalent surfaces on sides 910 and 930 of fixture 900. Also, the cavities 1090a and 1090b and the equivalent cavities on sides 910 and 930 of fixture 900 may or may not be symmetrically centered over LEDs 960. As was the case with embodiment 500, the ability to tune the curvature of the surfaces bounding cavities 1090a and 1090b as well as the equivalent cavities on sides 910 and 930 of fixture 900 may be very advantageous in that this will allow the distribution of light across reflector 1010 to be adjusted.

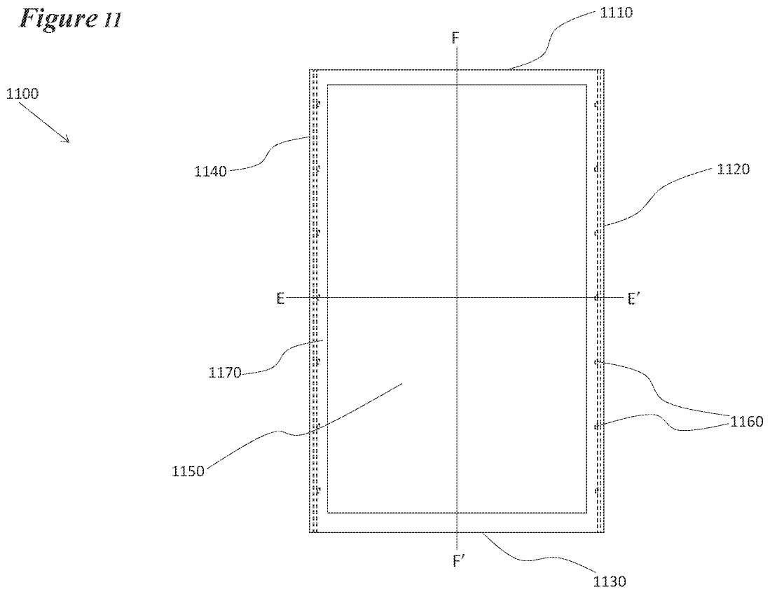

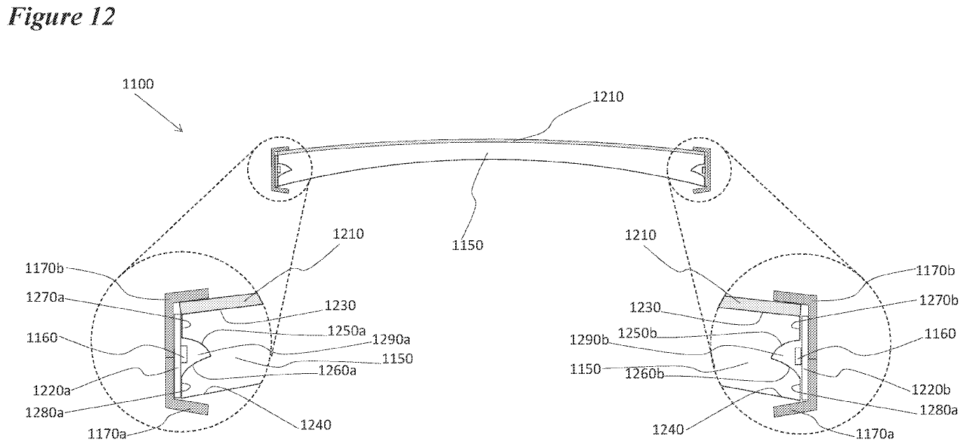

In embodiment 900 of the invention cavities 1090a and 1090b as well as their equivalents along sides 910 and 930 extend along all four sides of slab 950. It may be advantageous that similar cavities extend along only one, two or three sides of an analogous slab in other embodiments. In embodiment 900 the sides of slab 950 that extend along sides 910, 920, 930, and 940 of the downlight fixture 900 are all of the same length. In some applications it may be advantageous that the sides of the sides of the slab analogous to slab 950 and thus of the fixture analogous to fixture 900 not be of the same length. An embodiment 1100 of the invention that incorporates these options is illustrated in a plan view in FIG. 11 and in a cross-sectional view along axis EE′ in FIG. 12.

Sides 1120 and 1140 of down light fixture 1100 are longer than sides 1110 and 1130. Embodiment 1100 comprises a rectangular slab 1150 of transparent material such as polymethylmethacrylate or sol-gel glass and LEDs 1160. Slab 1150 is bounded front and back by two surfaces 1240 and 1230. On side 1140 slab 1150 is bounded by surfaces 1250a, 1260a, 1270a, and 1280a (as shown in FIG. 12). Curved surfaces 1250a and 1260a form two sides of a cavity 1290a that extends with a uniform cross-section along the side of slab 1150 that faces side 1140. Surfaces 1270a and 1280a connect the inner surfaces 1250a and 1260a to the surfaces 1230 and 1240 respectively. Slab 1150 is bounded by single surfaces without cavities analogous to cavities 1290a and 1290b on sides 1110 and 1130.

A flexible circuit board or tape 1220a is in contact with surfaces 1270a and 1280a of slab 1150 on side 1140 and a second circuit board or tape 1220b is in contact with surfaces 1270b and 1280b of slab 1150 on side 1120. LEDs 1160 are mounted on the flexible circuit boards 1220a and 1220b with their light emissive surfaces oriented so as to emit light outward from the flexible circuit board into cavities 1290a and 1290b. The LEDs are in contact with an electrical circuit and through that circuit to a power supply (not shown) such that they can be energized. The embodiment portrayed in FIGS. 11 and 12 has fourteen LEDs arrayed along sides 1120 and 1140 of slab 1150 and none on sides 1110 and 1130. The number of LEDs can be increased or reduced from this number depending on the light intensity required to be emitted from the fixture. A reflector 1210 is in contact with or is proximate to rear surface 1230 such that light exiting surface 1230 is reflected back into slab 1050. Reflector 1210 may be a diffuse reflector or a specular reflector or a combination of the two. A diffuse reflector is preferred. In this embodiment the bezel 1170 comprises two halves 1170a and 1170b that are joined together to support the flexible circuit boards 1220a and 1220b. Reflector 1010 may or may not have the same curvature as surface 1030 of slab 950. If it has a different curvature, an airgap between reflector 1210 and surface 1230 will result.

Surfaces 1230 and 1240 are curved along axis EE′ while there is no curvature along axis FF′. As was the case with the previously described embodiments, changing the position, curvature and orientation of surfaces 1250a, 1260a, 1250b, and 1260b allows one to tune the distribution of light across reflector 1210 and varying the curvatures of surfaces 1230, 1240, and reflector 1210 allows one to vary the distribution of light exiting fixture 1100.

The length of fixture 1100 can be extended along axis FF′ so as to produce a linear light lighting fixture of any desired length.

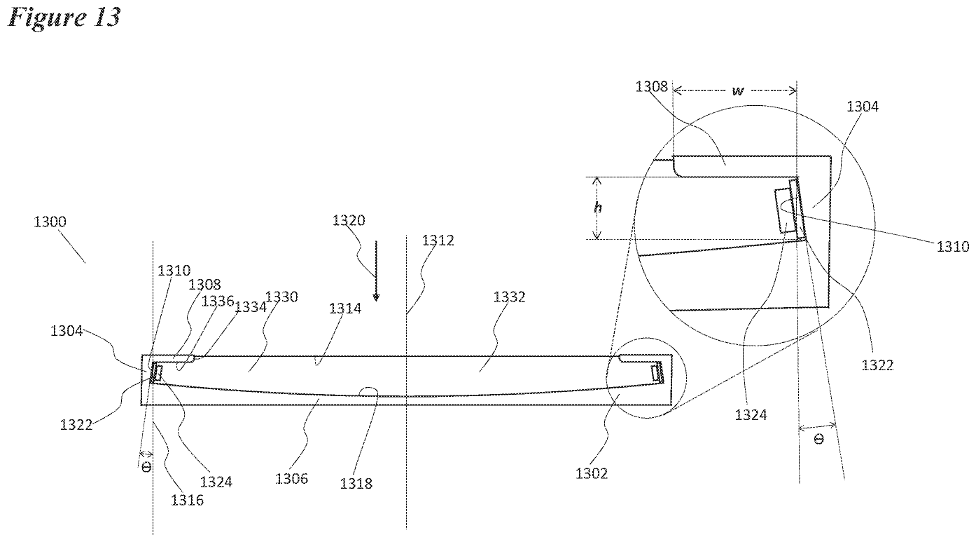

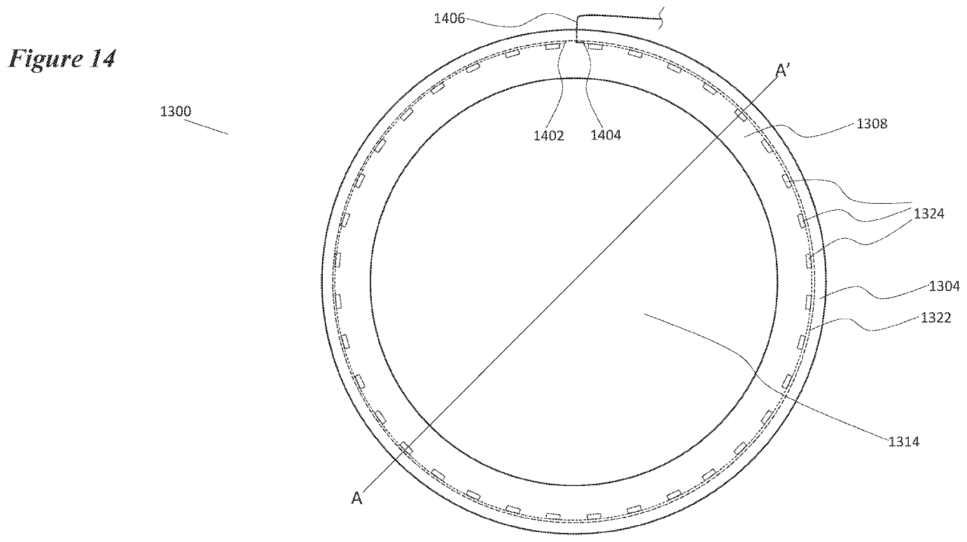

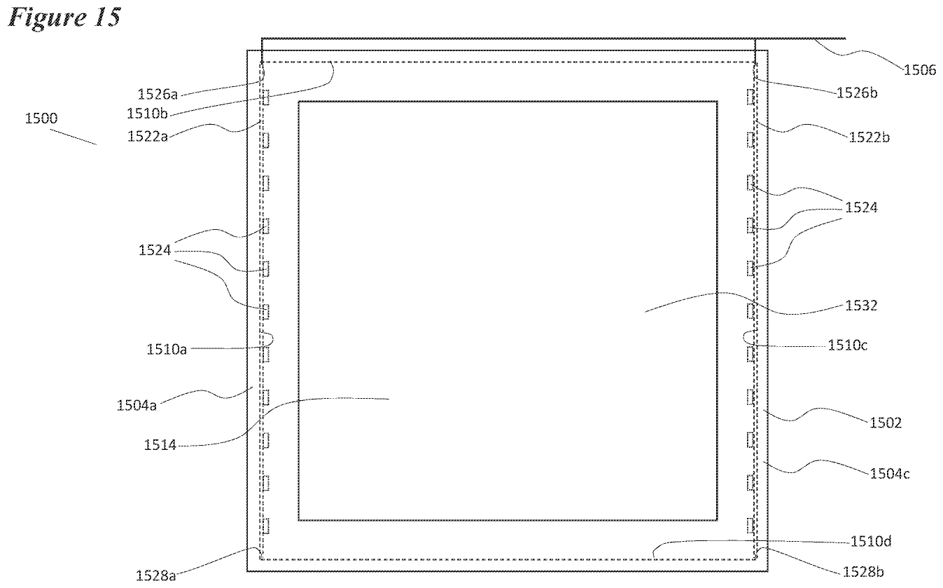

Another embodiment of the invention 1300 is portrayed in plan view in FIG. 14 and in cross-section along axis A-A′ in FIG. 13. Downlight fixture 1300 comprises an outer container 1302. Outer container 1302, in turn, comprises an outer wall 1304, a back wall 1306, and a forward light masking wall 1308. The entire outer container 1302 may be molded monolithically as one part or may comprise multiple components for ease of fabrication through molding. Outer wall 1304 may comprise a single inward facing surface 1310 if, for instance, back wall 1306 is circular in shape as is portrayed in the plan view of fixture 1300 in FIG. 14. Back wall 1306 may also be oval in shape. Outer walls like 1304 may also comprise multiple inward facing surfaces. For instance, downlight fixture 1500 portrayed in plan view in FIG. 15 has a square back wall 1506 and as a result outer wall 1504 comprises four inward facing surfaces 1510a, 1510b, 1510c, and 1510d. Back wall 1506 may be in the shape of any closed surface such as a triangle, a rectangle, a trapezoid or a pentagon. Symmetry plane 1312 bisects downlight 1300 and is perpendicular to the front emitting surface of the fixture 1314. Angle Θ between inward facing surface 1310 of outer wall 1304 and a plane 1316 parallel to symmetry plane 1310 may be 0 degrees, but it is preferred that angle Θ have a value between 2 degrees and 16 degrees and it is most preferred that angle Θ have a value of 8 degrees. Inward facing surface 1318 of back wall 1306 may be flat or planar, but it is preferred that it be a curved surface. It is further preferred that when surfaces 1318 of embodiment 1300 and other embodiments of the invention are viewed from direction 1320 (downward in FIG. 13), they have a concave curvature. The profile of the curvature may be spherical or parabolic or some other more mathematically complex profile. The profile of the curvature of the equivalent surface in embodiment four sided embodiments similar to 1500 is preferably that of a circular or parabolic cylinder if the back wall is in the shape of an elongated rectangle.

A circuit board, flexible circuit board, or tape substrate 1322 is situated on or attached to the inward facing surface 1310 of fixture 1300. In the case of embodiment 1500 there are two substrates 1522a and 1522b situated on or attached to two inward facing surfaces 1510a and 1510c of the outer walls 1504a and 1504c of outer case 1502. In this embodiment a series of light emitting diodes (LEDs) or other light emitting devices 1324 (or 1524) are mounted along substrates 1322 (or 1522a and b) extending in a straight line along the length of the substrate from one end 1402 (or 1526a and 1526b) to the other 1404 (or 1528a and 1528b). By optimizing the angle Θ the amount and uniformity of light exiting the downlight fixtures 1300 (or 1500) through emitting surface 1314 (or 1514) are maximized. Electrical connections 1406 or 1506 connects substrate(s) 1322 (or 1522a and b) to an energy source that powers LEDs 1324 (or 1524).

The walls of outer container 1302 or 1502 form an optical cavity 1330 or 1530 (not shown). This cavity contains a clear, transparent material 1332 or 1532 that has a front surface (1314 or 1514). Material 1332 or 1532 may be an optically clear potting compound that is poured into cavity 1330 or 1530 and cured to an optically clear, transparent solid in place. Material 1332 or 1532 may be an epoxy polymer, polyurethane, silicone rubber or any other suitable potting compound.

The function of forward light masking wall 1308 (or 1508) is to shield light emitted from LEDs 1324 or 1524 from being directly seen by a person looking at the downlight. To accomplish this the forward light masking wall 1308 (or 1508) must have a sufficient width w but not be so wide as to make the ratio of width of emitting surface be too small a fraction of total fixture width. To accomplish this, the width w is preferred to be between 1.5 and 2.5 times the interior height h of cavity 1330 or 1530. Most preferably w should be 2 times h.

Forward light masking wall 1308 or 1508 has an edge 1334 or 1534 that faces inward towards light emitting surface 1312 or 1512 and also a surface 1336 or 1536 that faces inward towards cavity 1330 or 1530. Edges 1334 or 1534 may intersect surfaces 1336 or 1536 at 90 degree angles, but it is preferred that the intersections of the edges and surfaces be rounded or “radiused” in order to maximized the energy efficiency of the downlight fixture. Other intersections between surfaces of the walls of cavity 1328 or cavity 1528 may be advantageously rounded or “radiused” as well. The surfaces of the surfaces of outer container 1302 or 1502 that contact transparent material 1330 or 1530 are preferred to have a white surface of high diffuse reflectivity.

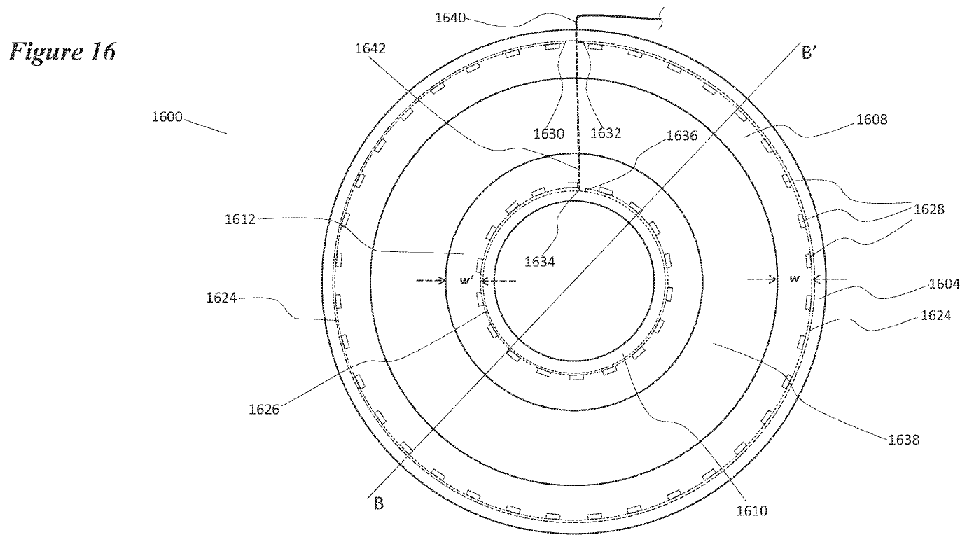

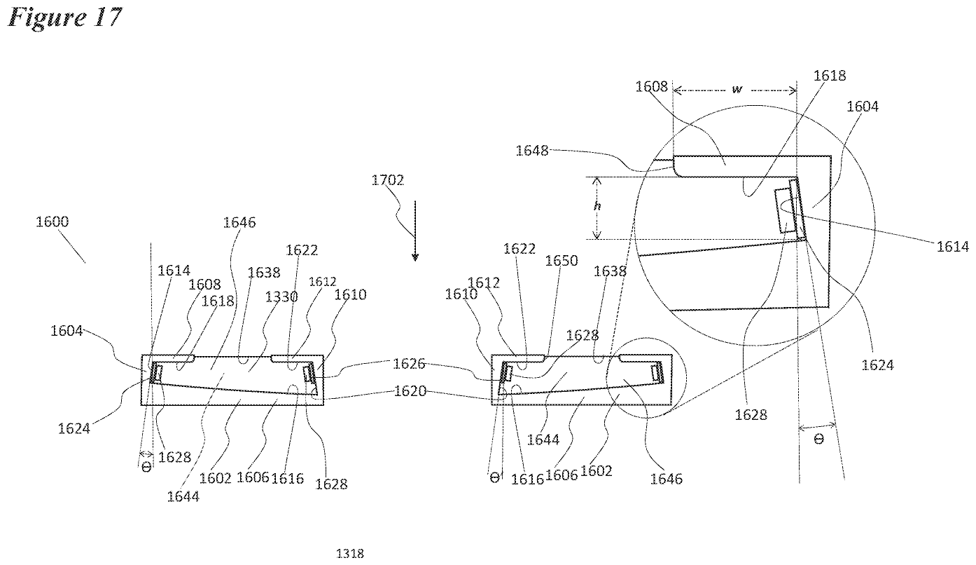

In embodiment 1300 LEDs 1324 are arranged in a single line along the length of circuit board, flexible circuit board or tape 1322. Other LED arrangements can be used, for instance, a double row of LEDs on a single circuit board or two circuit boards each with a single row of LEDs. The LEDs can all emit white light they can emit a mixture of colors. Yet another embodiment of the invention 1600 is shown in plan view in FIG. 16 and in a cross-sectional view along axis B and B′ in FIG. 17. Downlight fixture 1600 comprises an outer container 1602. Outer container 1602, in turn, comprises an outer wall 1604, a back wall 1606, and a forward light masking wall 1608. The entire outer container 1602 may be molded monolithically as one part or may comprise multiple components for ease of fabrication through molding. Back wall 1606 is in the shape of an annulus, that is to say, a circle with a circular “hole” in the middle. Downlight 1600 is an example of a series of embodiments that have back walls in the shape of closed plane geometric figures with one or more holes in the middle. A consequence of the annulus shape for back wall 1606 is that in addition to outer wall 1604 outer container 1602 comprises inner wall 1610 an inner forward light masking wall 1612. Outer wall 1604 has an inward facing surface 1614. Back wall 1606 has an inward facing surface 1616. Forward light masking wall has an inward facing surface 1618. Inner wall 1610 has an inward facing surface 1620. Inner forward light masking wall has an inward facing surface 1622.

As was the case in downlight 1300, angle Θ may be 0 degrees, but it is preferred to be between 2 and 16 degrees and is highly preferred to be 8 degrees. The angle Θ′, that is the analogous angle to the vertical direction in FIG. 17 of inward facing surface 1620, may also be 0 degrees, but is preferred to be between 2 and 16 degrees and is highly preferred to be 8 degrees.

Inward facing surface 1616 of back wall 1606 may be flat or planar, but it is preferred that it be a curved surface. It is further preferred that when surface 1616 of downlight 1600 is viewed from direction 1702 (downward in FIG. 17), it has a concave curvature. The profile of the curvature may be spherical or parabolic or some other more mathematically complex profile.

A circuit board, flexible circuit board, or tape substrate 1624 is situated on or attached to the inward facing surface 1614 of downlight fixture 1600. A second circuit board, flexible circuit board or tape substrate 1626 is situated on or attached to the inward facing surface 1620 of downlight fixture 1600. In this embodiment a series of light emitting diodes (LEDs) or other light emitting devices 1628 are mounted along substrate 1624 extending in a straight line along the length of the substrate from one end 1630 to the other 1632. Similarly, a series of light emitting diodes (LEDs) or other light emitting devices 1628 are mounted along substrate 1626 extending in a straight line along the length of the substrate from one end 1634 to the other 1636. By optimizing the angles Θ and Θ′, the amount and uniformity of light exiting the downlight fixture 1600 through emitting surface 1638 are maximized. Electrical connections 1640 and 1642 connect substrates 1624 and 1626 to an energy source that powers LEDs 1628.

The walls of outer container 1602 form an optical cavity 1644. This cavity contains a clear, transparent material 1646 that has a front surface 1638. Material 1646 may be an optically clear potting compound that is poured into cavity 1644 and cured to an optically clear, transparent solid in place. Material 1646 may be an epoxy polymer, polyurethane, silicone rubber or any other suitable potting compound.

The functions of forward light masking wall 1608 and inner forward light masking wall 1612 are to shield light emitted from LEDs 1628 from being directly seen by a person looking at the downlight. To accomplish this the forward light masking wall 1608 and inner forward light masking wall 1612 must have a sufficient widths w and w′ but not be so wide as to make the ratio of width of emitting surface be too small a fraction of total fixture width. To accomplish this, the width w is preferred to be between 1.5 and 2.5 times the interior height h of cavity 1644. Most preferably w should be 2 times h. Width w′ of inner forward light masking wall may be equal to width w. Forward light masking wall 1608 has an edge 1648 that faces inward towards light emitting surface 1638 and also a surface 1618 that faces inward towards cavity 1644. Edge 1648 may intersect surface 1618 at a 90 degree angle, but it is preferred that the intersections of edge 1648 and surface 1618 be rounded or “radiused” in order to maximized the energy efficiency of the downlight fixture. Similarly, inner forward light masking wall 1612 has an edge 1650 that faces inward towards light emitting surface 1638 and also a surface 1622 that faces inward towards cavity 1644. Edge 1650 may intersect surface 1622 at a 90 degree angle, but it is preferred that the intersections of edge 1650 and surface 1622 be rounded or “radiused” in order to maximized the energy efficiency of the downlight fixture. Other intersections between surfaces of the walls of cavity 1644 or may be advantageously rounded or “radiused” as well. For instance, the intersection of surfaces 1616 and 1620 may preferably be rounded or radiused. The surfaces of the surfaces of outer container 1602 that contact transparent material 1646 are preferred to have a white surface of high diffuse reflectivity.

In embodiment 1600 LEDs 1628 are arranged in single lines along the lengths of circuit boards, flexible circuit boards or substrate tapes 1624 and 1626. Other LED arrangements can be used, for instance, a double row of LEDs on a single circuit board or two circuit boards each with a single row of LEDs. The LEDs can all emit white light they can emit a mixture of colors.

The outer walls, back walls and forward light masking walls (e.g. 1304, 1306 and 1308) of the down lights exemplified by down lights 1300, 1500 and 1600 may be molded, machined or cast as single monolithic parts. Alternatively, the outer walls and forward light masking walls may be molded, machined or cast as single monolithic parts that can then be assembled with the back wall components. In the down lights exemplified by down lights 1300, 1500 and 1600, once the other components are assembled, the clear optical potting material (e.g. 1332) may be poured into the cavity formed by the outside walls (e.g. 1330) and cured.

The LED down lights described in this invention convert light emitted by LEDs into diffuse and uniform illumination over desired areas with very high energy efficiencies in excess of 95%.

1. A light fixture comprising:
an outer container having a back wall and one or more outer walls extending from the periphery of the back wall, wherein a cavity is defined by the one or more outer walls together with the back wall of the outer container, wherein one or more surfaces of the one or more outer walls of the outer container that face inward are one or more of coated with, painted with, or intrinsically have diffuse, white, reflecting surfaces, further wherein one or more of the inward facing surfaces of the one or more outer walls of the outer container have at least one circuit board, flexible circuit board, or tape mounted on or adhered thereon, further wherein the at least one circuit board, flexible circuit board, or tape has at least one light emitting device mounted thereon, and further wherein the cavity is filled with a clear, transparent material.

2. The light fixture of claim 1 wherein the back wall has the shape of a closed geometric figure.

3. The light fixture of claim 2 wherein the closed geometric figure is a circle.

4. The light fixture of claim 2 wherein the closed geometric figure is an oval.

5. The light fixture of claim 2 wherein the closed geometric figure is a square.

6. The light fixture of claim 2 wherein the closed geometric figure is a rectangle.

7. The light fixture of claim 2 wherein the closed geometric figure is a polygon.

8. The light fixture of claim 2 wherein the closed geometric figure is an annulus.

9. The light fixture of claim 1 wherein the outer container further comprises a forward light masking wall that extends inward from the one or more outer walls across the opening in the outer container so as to block direct viewing of the light emitting devices from outside of the light fixture.

10. The light fixture of claim 9 wherein one or more of the surfaces of the forward light masking wall that face inward into the cavity are coated with, painted with or intrinsically have diffuse, white reflecting surfaces.

11. The light fixture of claim 1 wherein the surface of back wall facing inward into the cavity is flat.

12. The light fixture of claim 1 wherein the surface of the back wall facing inward into the cavity is curved.

13. The light fixture of claim 12 wherein the surface of the back wall facing inward into the cavity is a portion of the surface of a sphere.

14. The light fixture of claim 12 wherein the surface of the back wall facing inward into the cavity is a portion of the surface of a paraboloid.

15. The light fixture of claim 12 wherein the surface of the back wall facing inward into the cavity is a portion of the surface of a cylinder.

16. The light fixture of claim 15 wherein the surface of the back wall facing inward into the cavity is a portion of the surface of a circular cylinder.

17. The light fixture of claim 15 wherein the surface of the back wall facing inward into the cavity is a portion of the surface of a parabolic cylinder.

18. The light fixture of claim 9 wherein the width w of the forward light masking wall (from the edge of the forward light masking wall that faces in towards the center of the fixture to the line along which the forward light masking wall intersects the inward facing surface of the outer wall along a line perpendicular to the central axis of symmetry of the fixture) is between 1.5 and 2.5 times the height h of the cavity (from the line along which the forward light masking wall intersects the inward facing surface of the outer wall to the inward facing surface of the back wall along a line parallel to the central axis of symmetry of the fixture).

19. The light fixture of claim 18 wherein the ratio of the width w to the height h is equal to 2.

20. The light fixture of claim 8 wherein the outer container further comprises an inner wall that extends around the periphery of the circular hole at the center of the annulus and extends upward from the back wall and wherein the outer container's outer wall, back wall, forward light masking wall and inner wall form a cavity with an annular cross-section.

21. The light fixture of claim 20 wherein the inward facing surface of the inner wall of the outer container has a circuit boards, flexible circuit board or tape mounted on or adhered to it.

22. The light fixture of claim 21 the circuit board, flexible circuit board, or tape has light emitting devices mounted on it.

23. The light fixture of claim 22 wherein an inner forward light masking wall extends outward from the outer container's inner wall across the opening in the outer container so as to block direct viewing of the light emitting devices mounted on the inner wall from outside of the light fixture.

24. The light fixture of claim 1 wherein the light emitting devices are light emitting diodes.

25. The light fixture of claim 22 wherein the light emitting devices are light emitting diodes.

26. (canceled)
